(19) United States
(12) Patent Application Publication
(10) Pub. No.: US 2005/0193876 A1
(43) Pub. Date: Sep. 8, 2005

(54) Hand held work performing device and method

(76) Inventor: Michael A. Broyles, Las Vegas, NV (US)

Correspondence Address: WEISS & MOY PC, 4204 NORTH BROWN AVENUE, SCOTTSDALE, AZ, 85251, US

(21) Appl. No.: 10/794,855

(22) Filed: Mar. 5, 2004

(51) Int. Cl. B25G 1/01

(52) U.S. Cl. 81/489

(57) ABSTRACT

Hand held work performing devices are illustrated and described with single or multiple heat shrunk substantially rigid thermoplastic layers located at critical areas of the handles for each of these hand held work performing devices to reduce vibration, to provide repairs and to increase the lifetime of these devices.

### FIELD OF THE INVENTION

This invention relates generally to work devices and methods therefor and, more particularly, to hand held work performing devices and methods therefor.

### BACKGROUND OF THE PRIOR ART

A large variety of work tools have been developed for carrying out different types of work related tasks. In some cases, work tools are needed for very large types of work tasks which require relatively large pieces of equipment. In many cases, work tools are needed for small work tasks, requiring the development of hand held tools or other relatively small devices.

In most cases, hand held tools or devices comprise two elements. One of the elements is a handle (for gripping by one hand) or handles (for gripping by both hands) and the other one of the two elements is the part or member used to perform the work application or function for the hand held tool or device. The handle or handles for some of the hand held tools or devices are typically wooden, plastic material or metallic. For the hand held tools or devices that have a handle or handles made of metal, the metal handle or handles usually provides a strong integral or unitary structure with the part or member of the tool or device that performs the work function.

Any person using a hand held work performing device is required to hold the device by the handle or handles to perform the work task. Thus, the integrity of the handle or handles of a hand held work performing device is a critical part of the device even though the handle or handles are not used to perform the actual work function.

One major problem associated with the handle or handles of such a device is, especially in the case of a wooden or plastic handle or handles, that the handle or handles break off or crack thereby rendering the device useless unless the handle or handles are replaced which may not be very easy to do. In some situations, a temporary repair of the handle may become a safety hazard for the user of the device.

Another major problem associated with the handle or handles of a hand held device (regardless if the handle or handles are made of wood, plastic, metal, etc.) is vibration. It is very unpleasant to use a hand held tool or device and have a great deal of vibration in the handle which causes difficulty in using the device optimally. This handle vibration problem will usually cause the handle to eventually crack or break if it is made of wood and will, in most cases, substantially reduce tool or device work efficiency because of the difficulty and/or discomfort in using a tool or device that has a handle or handles vibrating during tool or device use.

Additionally, wooden and fiber reinforced handles, over time, may develop splinters that may damage the hands of a person using the hand held tool or device.

Accordingly, a need existed to provide a device and/or method that would overcome these handle associated problems and, therefore, optimize use of a hand held tool or device, significantly reduce handle vibration, avoid breaking or cracking of the handle and to repair cracks, breakages or splinters that occur in a hand held tool or device.

### SUMMARY OF THE INVENTION

It is an object of this invention to provide an improved hand held work performing device and method.

It is a further object of this invention to provide an improved hand held work performing device and method that uses a handle or handles that significantly reduce vibration for the user of the device.

It is a still further object of this invention to provide an improved hand held work performing device and method that uses a handle or handles that significantly reduce breaking or cracking of the handle or handles.

It is another object of this invention to provide an improved hand held work performing device and method that uses a handle or handles that will both significantly reduce handle vibration and/or handle cracking.

It is a yet further object of this invention to provide an improved hand held work performing device and method that repairs a handle or handles that are cracked, broken or have splinters.

### BRIEF DESCRIPTION OF THE PREFERRED EMBODIMENTS

In accordance with one embodiment of this invention, a hand held work performing device is disclosed which comprises, in combination: hand held work performing device means for performing work; and at least one heat shrunk substantially cylindrical shaped means encircling at least one portion of the hand held work performing device means for both repairing and providing protection therefor and for significantly reducing shock and vibration thereof during use of the hand held work performing device means. The at least one heat shrunk substantially cylindrical shaped means comprises a heat shrunk substantially rigid thermoplastic layer having a pliable, split-resistant outer surface. For certain hand held work performing devices the at least one heat shrunk substantially cylindrical shaped means comprises a heat shrunk inner heat shrinkable substantially rigid thermoplastic layer having a pliable, split-resistant outer surface and having an inner surface in contact with an outer surface of the hand held work performing device means, and a heat shrunk outer heat shrinkable substantially rigid thermoplastic layer having a pliable, split-resistant outer surface and having at least a portion of an inner surface thereof in contact with at least a portion of the outer surface of the inner heat shrinkable substantially rigid thermoplastic layer. The at least one heat shrunk substantially cylindrical shaped means substantially encircles a handle portion of the hand held work performing device means.

In accordance with another embodiment of this invention, a method for preparing a hand held work performing device is disclosed which comprises the steps of: providing hand held work performing device means for performing work; and forming at least one heat shrunk substantially cylindrical shaped means encircling at least one portion of the hand held work performing device means for both repairing and providing protection therefor and for significantly reducing shock and vibration thereof during use of the hand held work performing device means.

The foregoing and other objects, features and advantages of this invention will be apparent from the following more particular description of the preferred embodiments of the invention as illustrated in the accompanying drawings.

### BRIEF DESCRIPTION OF THE DRAWINGS

FIG. 1 is a perspective view of a hammer after an inner heat shrinkable layer (or coating or sleeve) has been formed about an upper portion of a handle of the hammer, and prior to heat shrinking an outer heat shrinkable layer encircling the inner heat shrinkable layer and a portion of the upper handle portion.

FIG. 1A is a perspective view of an inner substantially cylindrical heat shrinkable substantially rigid thermoplastic member prior to being heat shrunk to form the heat shrinkable inner layer of the FIG. 1 embodiment.

FIG. 1B is a perspective view of an outer substantially cylindrical heat shrinkable substantially rigid thermoplastic member to provide a comparison between the outer and inner members and the loading or placement order on the handle of the hammer shown in FIG. 1, with the inner heat shrinkable layer being first to be positioned on the handle and the outer heat shrinkable layer being second to be positioned on the handle.

FIG. 1C is a perspective view of the hammer of FIG. 1 showing a portion of the handle of the hammer having a crack and a wrapping enclosing a portion of the hammer extending from a surface below the crack on one side of the handle of the hammer to a surface over a head of the hammer and to a surface below the crack of another side of the handle of the hammer (not shown).

FIG. 1D is a perspective view of the hammer of FIG. 1C showing a portion of the handle of the hammer having the crack and the wrapping encircled by the inner heat shrinkable layer (or coating or sleeve) after the inner heat shrinkable layer has been formed about the upper portion of the handle of the hammer, and prior to heat shrinking the outer heat shrinkable layer encircling the inner heat shrinkable layer and a portion of the upper handle.

FIG. 2 is a cross-sectional view taken along the line A-A of FIG. 1 showing the handle of the hammer encircled by the inner heat shrinkable layer after a heat shrinking operation and also after placement of the outer heat shrinkable layer in position about the handle, but prior to the heat shrinking thereof.

FIG. 3 is a view similar to FIG. 1 showing the hammer with both the inner heat shrinkable and outer heat shrinkable layers are heat shrunk to form the substantially dual heat shrunk (concentric) layers about an upper portion of the hammer handle.

FIG. 4 is a sectional view taken along the line B-B of FIG. 3 showing the inner heat shrinkable layer encircling an upper portion of the handle and the outer heat shrinkable layer encircling both the inner heat shrinkable layer and a portion of the handle.

FIG. 5 is a side elevational view of a pipe wrench having a single heat shrinkable layer that is heat shrunk and located about a handle portion of the pipe wrench.

FIG. 6 is a side elevational view of an adjustable crescent wrench showing a single heat shrinkable layer that is heat shrunk and located about a handle portion of the adjustable crescent wrench.

FIG. 7 is a perspective view of a sledge hammer showing substantially dual heat shrinkable (concentric) layers that are heat shrunk and located about an upper portion of the sledge hammer handle.

FIG. 8 is a perspective view of an axe showing substantially dual heat shrinkable (concentric) layers that are heat shrunk and located about an upper portion of the axe handle.

FIG. 9 is a perspective view of a mallet showing substantially dual heat shrinkable (concentric) layers that are heat shrunk and located about an upper portion of the mallet handle.

FIG. 10 is a side elevational view of a pick showing substantially dual heat shrinkable (concentric) layers that are heat shrunk and located about an upper portion of the pick handle.

FIG. 11 is a side elevational view of a socket wrench showing a single heat shrinkable layer that is heat shrunk and located about a handle portion of the socket wrench.

FIG. 12 is a side elevational view of an open end wrench showing a single heat shrinkable layer that is heat shrunk and located about a handle portion of the open end wrench.

FIG. 13 is a side elevational view of a pruning shears having a pair of handles showing a single heat shrinkable layer that is heat shrunk and located about a handle portion of each one of the pair of handles.

FIG. 14 is a side elevational view of a ball peen hammer showing substantially dual heat shrinkable (concentric) layers that are heat shrunk and located about an upper portion of the handle of the ball peen hammer.

FIG. 15 is a side elevational view of a rock hammer showing substantially dual heat shrinkable (concentric) layers that are heat shrunk and located about an upper portion of the rock hammer.

FIG. 16 is a side elevational view of a chisel showing a single heat shrinkable layer that is heat shrunk and located about a handle portion of the chisel.

FIG. 17 is a side elevational view of a punch showing a single heat shrinkable layer that is heat shrunk and located about a handle portion of the punch.

FIG. 18 is a side elevational view of a wheel barrow showing one of a pair of handles therefor having a single heat shrinkable layer that is heat shrunk and located about a handle portion of each handle.

FIG. 19 is a side elevational view of a crowbar showing a single heat shrinkable layer that is heat shrunk and located about a handle portion of the crowbar.

FIG. 20 is a side elevational view of a digging bar showing a single heat shrinkable layer that is heat shrunk and located about a handle portion of the digging bar.

FIG. 21 is a side elevational view of a pitch fork showing a single heat shrinkable layer that is heat shrunk and located about a portion of the handle of the pitch fork.

FIG. 21A is an exploded side elevational view of a top portion of the handle of the pitch fork of FIG. 21 showing a cap covering a top portion of the handle of the pitch fork and a portion of the single heat shrinkable layer that is heat shrunk and located about a portion of the cap, and a portion of the single heat shrinkable layer that is heat shrunk and located about the handle of the pitch fork.

FIG. 22 is a side elevational view of a mattock showing substantially dual heat shrinkable (concentric) layers that are heat shrunk and located about an upper portion of a handle of the mattock.

FIG. 23 is a side elevational view of a hoe showing a single heat shrinkable layer that is heat shrunk and located about a portion of the handle of the hoe.

FIG. 24 is a side elevational view of a mop showing a single heat shrinkable layer that is heat shrunk and located about a portion of the handle of the mop.

FIG. 25 is a side elevational view of a rake showing a single heat shrinkable layer that is heat shrunk and located about a portion of the handle of the rake.

FIG. 26 is a perspective view of a push broom showing a single heat shrinkable layer that is heat shrunk and located about a substantial portion of the handle of the push broom.

FIG. 27 is a side elevational view of a shovel showing a single heat shrinkable layer that is heat shrunk and located about a portion of the handle of the shovel.

FIG. 28 is a side elevational view of a baseball bat showing a single heat shrinkable layer that is heat shrunk and located about a portion of the handle of the baseball bat.

### DESCRIPTION OF THE INVENTION

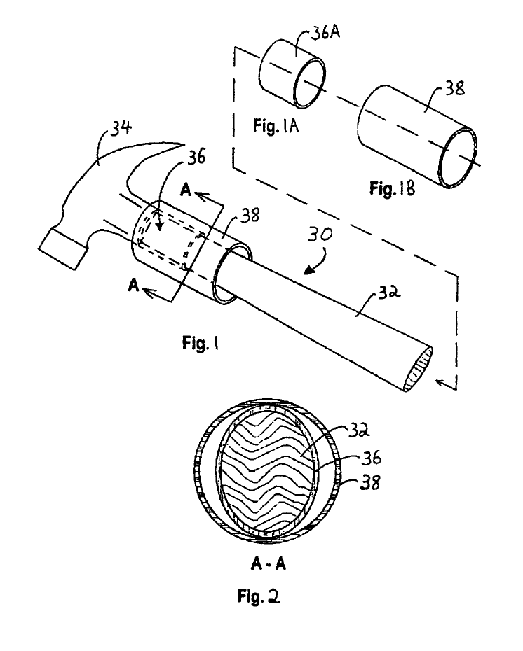

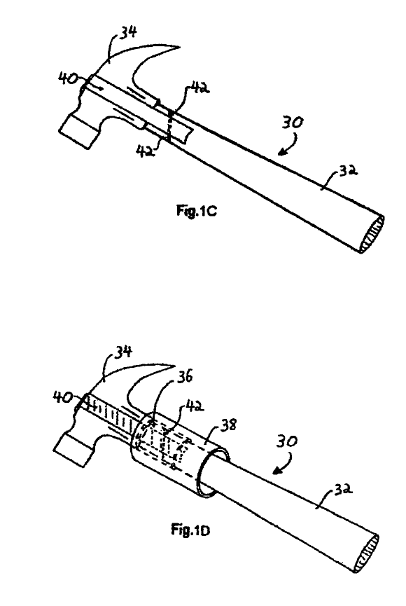

Referring to FIG. 1, reference numeral 30 generally designates a hammer which provides one embodiment of a hand held work performing device means. In the embodiment of FIG. 1 the hammer 30 has a handle 32 which is preferably attached to a head 34 of the hammer 30 by having an upper portion of the handle 32 extending through an opening (not shown) in the head 34 and connected within the opening to the head 34. Encircling an upper portion of the handle 32 preferably below the head 34 is a heat shrunk substantially cylindrical shaped means or layer 36. The heat shrunk layer 36 is preferably formed as follows. A heat shrinkable cylindrical shaped section 36A (as shown in FIG. 1A) of a heat shrinkable substantially rigid thermoplastic material is heated to a temperature sufficient to cause the cylindrical shaped section 36A to shrink around the upper portion of the handle 32 after placing the heat shrinkable cylindrical shaped section 36A in position about the upper portion of the handle 32. Examples of suitable heat shrinkable substantially rigid thermoplastic materials are a thermoplastic polyolefin known as CHO-SHRINK® manufactured by the Chomerics division of the Seal Group of the Parker Hannifin Corporation, MA, U.S.A., and more preferably a thermoplastic split-resistant cross-linked polyolefin having an inner adhesive layer known as 3M™ CCT 1300 and manufactured by Minnesota Mining and Manufacturing (3M™), MN, U.S.A. which, are otherwise used for electrical insulation and weather resistance for telephone and power line electrical cables and not used principally for structural integrity. It is to be understood that substantial benefit may be obtained by using other kinds of rigid thermoplastic materials including PVC, nylon, polyurethane and the like and other 3M™ CCT, EPS, MDT split-resistant cross-linked polyolefins comprising an inner adhesive layer. Typically, the polyolefin component of 3M™ CCT 1300 has a tensile strength of about 2000 psi, operating temperature of about −55° C. to about 110° C. and heat shrink temperature of about 121° C., while the adhesive component of 3M™ CCT 1300 has a softening point of about 90° C. and a peel strength of about 30 pli to polyethylene, a peel strength of about 10 pli to PVC and a peel strength of about 40 pli to aluminum. Typical recovered outer wall thickness for the 3M™ CCT materials range from about 0.08 to 0.12 inches. Typical recovered outer wall thickness for the 3M™ EPS materials range from about 0.04 to 0.1 inches, and for the 3M™ MDT materials range from about 0.09 to 0.15 inches. The 3M™ MDT materials are also non-flammable. Various heating means can be used to heat shrink the cylindrical shaped section 36A such as the use of a furnace oven or the like or, if desired, the use of a hand held blow dryer that is used to generate heat to blow dry a person's wet hair. The amount of heat that is used for the heat shrink operation is dependent upon the temperature, the time of the heat treatment, the thickness and/or length of the heat shrinkable material, the type of heat shrinkable material, whether the heat shrinkable material is applied over a metal object that will itself produce internal heat when heated or an object that is low in heat conduction such as wood, plastic, etc. Also, the size of the object, especially the diameter thereof, that is to have the heat shrinkable material heat shrunk thereon and the material thereof (high or low heat conductivity) can be a factor in efficiently and reliably carrying out the heat shrinking operation. For fast heat shrinking operations without expensive or elaborate equipment, the hand held blow dryer has been found to be particularly useful especially because of the relative portability thereof and the advantage of being able to carry out the heat shrink operation in any field type location where there is a source of electrical power to operate the hand held blow dryer. It is to be understood that substantial benefit for heat shrinking can be obtained by using other portable heating means such as a blow torch, especially when the heat shrink material is non-flammable. The use of the above described 3M heat shrinkable material provides a substantially rigid thermoplastic coating or layer 36 for the hammer 30 around the upper portion of the handle 32 thereof.

The substantially rigid thermoplastic (heat shrunk) layer 36 located around the upper portion of the handle 32 of the hammer 30 provides a number of unexpected results. One significant unexpected result is that there is almost no vibration for a person holding the lower end of the handle 32 in using the hammer 30 for any type of hammering operation when the portion of the hammer 30 below the head 34 (on the outside or exterior surface of the heat shrunk layer 36) is struck which occurs, on occasions, during use of the hammer especially over an extended period of time. The lifetime of the use of the hammer 30 is significantly greater because the hammer's handle 32 can now withstand many more blows below the head 34 of the hammer 30, thereby resulting in extended use and, in effect, a lower life time cost.

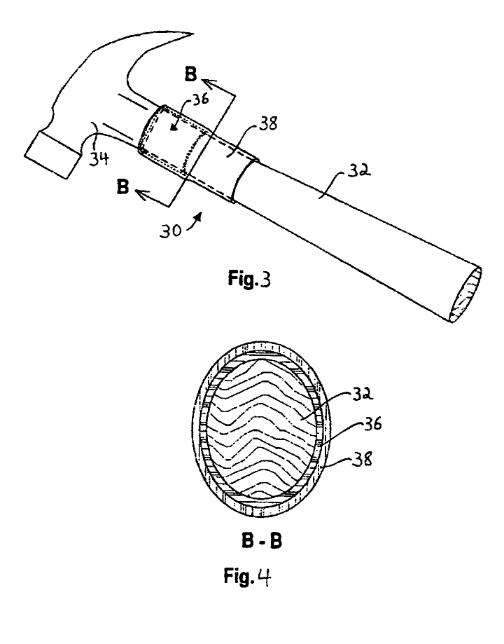

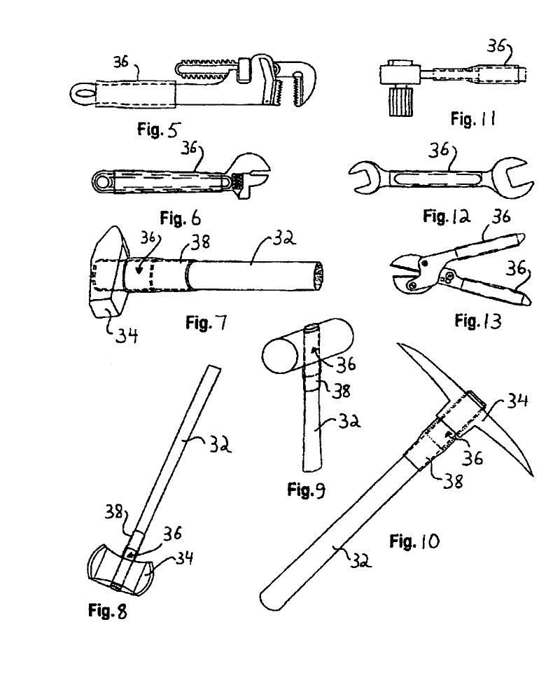

In order to even further increase the lifetime of the hammer 30 and to further reduce vibration of the handle 32, a second or outer heat shrinkable cylindrical shaped layer 38 is placed, as shown in FIG. 1 over the inner heat shrinkable layer 36 that is heat shrunk. Referring to FIGS. 1A and 1B the outer heat shrinkable layer 38 is cylindrical shaped and preferably longer in length and, if desired, slightly larger in diameter than the heat shrinkable section 36A (see FIG. 1A) that is used to form (after the above described heat shrink operation) the inner heat shrinkable layer 36 of FIG. 1. Thus, as shown in FIGS. 1 and 2, the heat shrinkable outer layer 38 is ready in position to be heat shrunk (as shown with reference to FIGS. 3 and 4) about both the inner (earlier) heat shrinkable layer 36 and a portion of the upper portion of the handle 32. This dual inner and outer heat shrinkable layer (36 and 38) combination that is heat shrunk has been found to be even more vibration and blow resistant for the hammer 30 than the use of a single heat shrinkable layer 36 that is heat shrunk. Accordingly, the hammer 30, if made with a wooden handle, can now have a very long and extended lifetime of use because of the inner heat shrinkable layer 36 and outer heat shrinkable layer 38 that are both heat shrunk. In addition, because the preferred substantially rigid thermoplastic 3M heat shrinkable material comprises an inner adhesive layer, a substantial portion of an inner surface of the inner heat shrinkable layer 36 that is heat shrunk is more tightly coupled to a portion of an outer surface of the handle 32 and a portion of an inner surface of the outer heat shrinkable layer 38 that is heat shrunk is more tightly coupled to an outer portion of a surface of the inner heat shrinkable layer 36.

Referring to FIG. 1C a portion of the handle 32 of the hammer 30 having a crack 40 is shown. In FIG. 1C, a wrapping 42 encloses a portion of the hammer 30 extending from a surface below the crack 40 on one side of the handle of the hammer to a surface over the head 34 of the hammer 30 and to a surface below the crack 40 of another side of the handle 32 of the hammer 30(not shown). The wrapping 42 provides additional longitudinal strengthening in a portion of the handle 32 of the hammer 30 when the heat shrinkable inner layer 36 encloses the wrapping 42 and the handle 32 of the hammer 30 after heat shrinking. The wrapping 42 is particularly effective in the case where the crack 40 occurs in a portion of the handle 32 encased by the head 34 of the hammer 30. Referring to FIG. 1D, a portion of the handle 32 of the hammer 30 having the crack 40 and the wrapping 42 encircled by the inner heat shrinkable layer 36 (or coating or sleeve) after the inner heat shrinkable layer 36 has been formed about the upper portion of the handle 32 of the hammer 30, and prior to heat shrinking the outer heat shrinkable layer 38 encircling the inner heat shrinkable layer 36 and a portion of the upper handle 32. On heat shrinking the outer heat shrinkable layer 38 in the example shown in FIG. 1D, an extremely durable repair is made for the handle 32 of the hammer 30 having the crack 40.

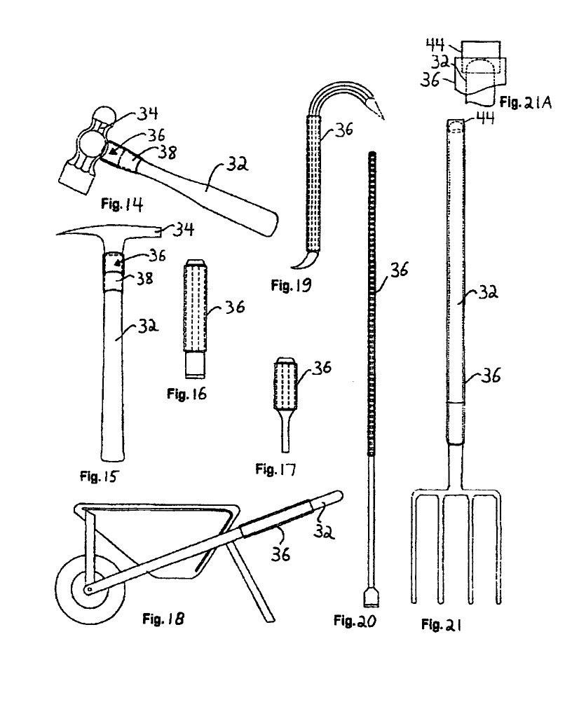

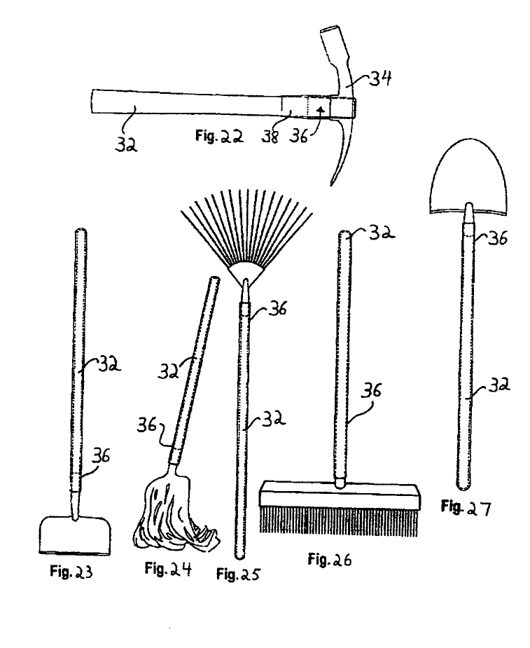

Correspondingly, the sledge hammer embodiment of FIG. 7, the axe embodiment of FIG. 8, the mallet embodiment of FIG. 9, the pick embodiment of FIG. 10, the ball peen hammer embodiment of FIG. 14, the rock hammer embodiment of FIG. 15 and the mattock embodiment of FIG. 22 each illustrate how the undesired handle vibration can be similarly significantly reduced and the lifetime use of these hand held work performing devices can be significantly increased when using wooden handles for these devices. As described above and as illustrated in FIGS. 1, 1A, 1B, 2, 3 and 4, the use of two substantially cylindrical (inner and outer) heat shrinkable layers 36 and 38 provide significant advantages over such devices that do not have a heat shrinkable layer 36 or a combination of two (inner and outer) heat shrinkable layers 36 and 38. For the sake of convenience, the same reference numbers used in FIGS., 1, 1A, 1B, 2, 3, and 4 are used, if applicable, for the corresponding elements for the embodiments of FIGS. 7, 8, 9, 10, 14, 15 and 22. When the handle 32 of any one of the embodiments of FIGS. 7, 8, 9, 10, 14, 15 and 22 has the crack 40, the wrapping 42 is effective in repairing the handle 32 as illustrated and described (see above) for the hammer 30 of FIGS. 1C and 1D.

In order to further insure increased reliability and thus increased device lifetime, it is preferred to extend the inner heat shrinkable layer 36 to the very top of the upper portion of the handle 32 for the sledge hammer embodiment of FIG. 7, the axe embodiment of FIG. 8, the mallet embodiment of FIG. 9 and the mattock embodiment of FIG. 22. Thus, in these embodiments, the portion of each of the handles 32 inside each of the heads 34 is also protected by at least the inner heat shrinkable layer 36 that is heat shrunk and provides an even further significant advantage due to the relatively larger weight of the larger heads 34 of these embodiments as compared to the head 34 of the hammer 30 of the FIGS. 1, 1A, 1B, 2, 3 and 4 embodiment.

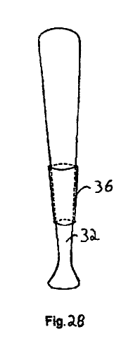

In the other embodiments illustrated in FIG. 5 (pipe wrench), FIG. 6 (adjustable crescent wrench), FIG. 11 (socket wrench), FIG. 12 (open end wrench), FIG. 13 (pruning shears having a pair of handles), FIG. 16 (chisel), FIG. 17 (punch), FIG. 18 (wheel barrow having a pair of handles), FIG. 19 (crowbar), FIG. 20 (digging bar), FIG. 21 (pitch fork), FIG. 23 (hoe), FIG. 24 (mop), FIG. 25 (rake), FIG. 26 (push broom), FIG. 27 (shovel) and FIG. 28 (baseball bat), preferably a single heat shrinkable layer 36 is used on the handle or handles of each of these hand held work performing devices. It is preferred to extend the inner heat shrinkable layer 36 to the very top of the upper portion of the handle 32 for the pitch fork embodiment (FIG. 21), the hoe embodiment (FIG. 23), the mop embodiment (FIG. 24), the rake embodiment (FIG. 25), the push broom embodiment (FIG. 26) and the shovel embodiment (FIG. 27) in order to further insure increased reliability and thus increased device lifetime. According to the pitch fork embodiment of FIG. 21A, a cap 44 covers a top portion of the handle 32 of the pitch fork and a portion of the single heat shrinkable layer 36 that is heat shrunk and located about a portion of the cap 44, and a further portion of the single heat shrinkable layer 36 that is heat shrunk and located about the handle 32 of the pitch fork to provide a smooth and finished appearance to the top portion of the handle 32 of the pitch fork. It is to be understood that the cap 44 can be used in the sledge hammer embodiment of FIG. 7, the axe embodiment of FIG. 8, the mallet embodiment of FIG. 9, the mattock embodiment of FIG. 22, the hoe embodiment (FIG. 23), the mop embodiment (FIG. 24), the rake embodiment (FIG. 25), the push broom embodiment (FIG. 26) and the shovel embodiment (FIG. 27). Even though a number of these hand held work performing devices have metal handles, the single heat shrinkable layer 36 which is heat shrunk provides significantly reduced vibration for these handles thereby permitting a greater comfort and resultant ease in the use of these hand held work performing devices. If desired for some applications, more than two heat shrinkable layers can be used. Additionally, the heat shrinkable layer or layers can be used in other locations, if desired. Furthermore, rust reduction of these critical areas of each of these tools is achieved because of the heat shrinkable layer 36. It is to be understood that one or more layers of heat shrinkable material is effective in repairing the handle 32 when the handle 32 of any one of the embodiments of FIGS. 3-28 has the crack 40 or more than one crack 40, as illustrated and described (see above) for the hammer 30 of FIGS. 1C and 1D, thereby extending the life of the hand held work performing device. Additionally, the use of one or more layers of heat shrinkable material when used over a rough sliver containing wooden handle or a rough highly used metal handle prevents injury to the hands of a person using a defective hand held work performing device.

While a number of embodiments of hand held work performing devices have been disclosed herein, it should be understood that the inner heat shrinkable layer 36 (and, if desired, the outer heat shrinkable layer 38) can be used for other (not shown) embodiments of hand held work performing devices and, accordingly, the patent claims below are intended to cover such other (not shown) embodiments.

While the invention has been particularly shown and described with reference to the preferred embodiments thereof, it will be understood by those skilled in the art that the foregoing and other changes in form and details may be made therein without departing from the spirit and scope of the invention.

1. A hand held work performing device comprising, in combination:
hand held work performing device means for performing work; and
at least one heat shrunk substantially cylindrical shaped means encircling at least one portion of said hand held work performing device means for both repairing and providing protection therefor and for significantly reducing shock and vibration thereof during use of said hand held work performing device means.

2. The device of claim 1 wherein said at least one heat shrunk substantially cylindrical shaped means comprising a heat shrunk substantially rigid thermoplastic layer having a pliable, split-resistant outer surface.

3. The device of claim 1 wherein said at least one heat shrunk substantially cylindrical shaped means comprising a heat shrunk inner heat shrinkable substantially rigid thermoplastic layer having a pliable, split-resistant outer surface and having an inner surface in contact with an outer surface of said hand held work performing device means, and a heat shrunk outer heat shrinkable substantially rigid thermoplastic layer having a pliable, split-resistant outer surface and having at least a portion of an inner surface thereof in contact with at least a portion of said outer surface of said inner heat shrinkable substantially rigid thermoplastic layer.

4. The device of claim 3 wherein said outer heat shrinkable substantially rigid thermoplastic layer enclosing said inner heat shrinkable substantially rigid thermoplastic layer.

5. The device of claim 1 wherein said hand held work performing device means being a hammer having a head portion and a handle portion, said at least one heat shrunk substantially cylindrical shaped means encircling an upper portion of said handle portion adjacent to said head portion.

6. The device of claim 3 wherein said hand held work performing device means being a hammer having a head portion and a handle portion, said at least one heat shrunk substantially cylindrical shaped means encircling an upper portion of said handle portion adjacent to said head portion.

7. The device of claim 6 wherein said inner heat shrunk substantially rigid polyolefin layer being in contact with said upper portion of said handle portion, said outer heat shrunk substantially rigid polyolefin layer having an inner surface being partly in contact with said outer surface of said inner heat shrunk substantially rigid thermoplastic layer and partly in contact with an outer surface portion of said upper portion of said handle portion.

8. The device of claim 7 wherein said handle portion of said hammer being made of wood.

9. The device of claim 1 wherein said hand-held work performing device means having a head portion and a handle portion, said handle portion having a first side and a second side, a wrapping enclosing a portion of said hand held work performing device means extending from a surface on the first side of said handle portion of said hand held work performing device means to a surface over a head of said hand held work performing device means and to a surface of the second side of said handle portion of said hand held work performing device means, said at least one heat shrunk substantially cylindrical shaped means encircling an upper portion of said handle portion adjacent to said head portion and encircling said wrapping so as to provide a durable repair of said hand held work performing device means.

10. The device of claim 1 wherein said hand held work performing device means is a pipe wrench having a handle portion, said at least one heat shrunk substantially cylindrical shaped means encircling a lower portion of said handle portion.

11. The device of claim 1 wherein said hand held work performing device means is a baseball bat having a handle portion, said at least one heat shrunk substantially cylindrical shaped means encircling a lower portion of said handle portion.

12. The device of claim 1 wherein said hand held work performing device means is an adjustable crescent wrench having a handle portion, said at least one heat shrunk substantially cylindrical shaped means encircling substantially all of said handle portion.

13. The device of claim 1 wherein said hand held work performing device means is a socket wrench having a handle portion, said at least one heat shrunk substantially cylindrical shaped means encircling a substantial portion of said handle portion.

14. The device of claim 1 wherein said hand held work performing device means is an open end wrench having a handle portion intermediate first and second jaw portions, said at least one heat shrunk substantially cylindrical shaped means encircling a substantial portion of said handle portion.

15. The device of claim 1 wherein said hand held work performing device means are pruning shears having a pair of handle portions, said at least one heat shrunk substantially cylindrical shaped means encircling a substantial portion of each one of said pair of handle portions.

16. The device of claim 1 wherein said hand held work performing device means is a chisel having a handle portion, said at least one heat shrunk substantially cylindrical shaped means encircling substantially all of said handle portion.

17. The device of claim 1 wherein said hand held work performing device means is a punch having a handle portion, said at least one heat shrunk substantially cylindrical shaped means encircling substantially all of said handle portion.

18. The device of claim 1 wherein said hand held work performing device means is a crowbar having a linear handle portion, said at least one heat shrunk substantially cylindrical shaped means encircling substantially all of said linear handle portion.

19. The device of claim 1 wherein said hand held work performing device means is a digging bar having an elongated handle portion, said at least one heat shrunk substantially cylindrical shaped means encircling a substantial portion of said elongated handle portion.

20. The device of claim 1 wherein said hand held work performing device means is a pitch fork having a plurality of pitch blade elements connected to a single support member and also having an extended handle portion having one end thereof in contact with an outer end of said single support member, said at least one heat shrunk substantially cylindrical shaped means encircling both a portion of said one end of said extended handle portion and a portion of said single support member located adjacent to said one end of said extended handle portion.

21. The device of claim 1 wherein said hand held work performing device means is a wheelbarrow having a pair of handle members, said at least one heat shrunk substantially cylindrical shaped means encircling an upper portion of each one of said pair of handle members.

22. The device of claim 1 wherein said hand held work performing device means is a hoe having a spade portion connected to a support member and an extended handle portion having one end thereof in contact with an outer end of said support member, said at least one heat shrunk substantially cylindrical shaped means encircling both a portion of said one end of said extended handle portion and a portion of said support member located adjacent to said one end of said extended handle portion.

23. The device of claim 1 wherein said hand held work performing device means is a mop having a mop head connected to a support member and an extended handle portion connected to said support member, said at least one heat shrunk substantially cylindrical shaped means encircling both a portion of said extended handle portion that is connected to said support member and a portion of said support member connected to said extended handle portion.

24. The device of claim 1 wherein said hand held work performing device means is a rake having a rake head connected to a support member and an extended handle portion connected to said support member, said at heat one heat shrunk substantially cylindrical shaped means encircling both a portion of said support member and a portion of said extended handle portion that is connected to said support member.

25. The device of claim 1 wherein said hand held work performing device means is a push broom having an extended handle portion, said at least one heat shrunk substantially cylindrical shaped means encircling a substantial portion of said extended handle portion.

26. The device of claim 1 wherein said hand held work performing device means is a shovel having a spade head portion connected to a support member and an extended handle portion, said at least one heat shrunk substantially cylindrical shaped means encircling both a portion of said support member and an end portion of said extended handle portion that is in contact with said support member.

27. The device of claim 3 wherein said hand held work performing device means is a sledge hammer having a head portion and a handle portion, said heat shrunk inner heat shrinkable substantially rigid thermoplastic layer being in contact with an upper portion of said handle portion, said heat shrunk outer heat shrinkable substantially rigid thermoplastic layer being in contact with both said heat shrunk inner heat shrinkable substantially rigid thermoplastic layer and a portion of said handle portion.

28. The device of claim 3 wherein said hand held work performing device means is an axe having a head portion and a handle portion, said heat shrunk inner heat shrinkable substantially rigid thermoplastic layer being in contact with an upper portion of said handle portion, said heat shrunk outer heat shrinkable substantially rigid thermoplastic layer being in contact with both said heat shrunk inner heat shrinkable substantially rigid thermoplastic layer and a portion of said handle portion.

29. The device of claim 3 wherein said hand held work performing device means is a mallet having a head portion and a handle portion, said heat shrunk inner heat shrinkable substantially rigid thermoplastic layer being in contact with an upper portion of said handle portion, said heat shrunk outer heat shrinkable substantially rigid thermoplastic layer being in contact with both said heat shrunk inner heat shrinkable substantially rigid thermoplastic layer and a portion of said handle portion.

30. The device of claim 3 wherein said hand held work performing device means is a pick having a head portion and a handle portion, said heat shrunk inner heat shrinkable substantially rigid thermoplastic layer being in contact with an upper portion of said handle portion, said heat shrunk outer heat shrinkable substantially rigid thermoplastic layer being in contact with both said heat shrunk inner heat shrinkable substantially rigid thermoplastic layer and a portion of said handle portion.

31. The device of claim 3 wherein said hand held work performing device means is a ball peen hammer having a head portion and a handle portion, said heat shrunk inner heat shrinkable substantially rigid thermoplastic layer being in contact with an upper portion of said handle portion, said heat shrunk outer heat shrinkable substantially rigid thermoplastic layer being in contact with both said heat shrunk inner heat shrinkable substantially rigid thermoplastic layer and a portion of said handle portion.

32. The device of claim 3 wherein said hand held work performing device means is a rock hammer having, a head portion and a handle portion, said heat shrunk inner heat shrinkable substantially rigid thermoplastic layer being in contact with an upper portion of said handle portion, said heat shrunk outer heat shrinkable substantially rigid thermoplastic layer being in contact with both said heat shrunk inner heat shrinkable substantially rigid thermoplastic layer and a portion of said handle portion.

33. The device of claim 3 wherein said hand held work performing device means is a mattock having a head portion and a handle portion, said heat shrunk inner heat shrinkable substantially rigid thermoplastic layer being in contact with an upper portion of said handle portion, said heat shrunk outer heat shrinkable substantially rigid thermoplastic layer being in contact with both said heat shrunk inner heat shrinkable substantially rigid thermoplastic layer and a portion of said handle portion.

34. The device of claim 2 wherein said substantially rigid thermoplastic layer is selected from the group consisting of polyolefin, nylon, polyvinyl chloride and polyurethane.

35. The device of claim 1 wherein an inner surface of said at least one heat shrunk substantially cylindrical shaped means comprises an adhesive for more tightly coupling to a portion of an outer surface of said hand held work performing device.

36. A method for preparing a hand held work performing device comprising the steps of:
providing hand held work performing device means for performing work; and
forming at least one heat shrunk substantially cylindrical shaped means encircling at least one portion of said hand held work performing device means for both repairing and providing protection therefor and for significantly reducing shock and vibration thereof during use of said hand held work performing device means.
